(19) United States
(12) Patent Application Publication
(10) Pub. No.: US 2025/0060712 A1
(43) Pub. Date: Feb. 20, 2025

(54) METHOD, APPARATUS AND SYSTEM FOR USE IN MANUFACTURING A MATERIAL

(71) Applicant: Henkel AG & Co. KGaA, Duesseldorf (DE)

(72) Inventors: Nick TALKEN, Concord, CA (US); Natarajan CHENNIMALAI KUMAR, Concord, CA (US); Zack KISNER, Concord, CA (US)

(73) Assignee: Henkel AG & Co. KGaA, Duesseldorf (DE)

(21) Appl. No.: 18/719,796

(22) PCT Filed: Nov. 29, 2022
(86) PCT No.: PCT/EP2022/083632

§ 371 Date: Jun. 13, 2024

Related U.S. Application Data
(60) Provisional application No. 63/290,792, filed on Dec. 17, 2021.

(51) Int. Cl. G05B 13/04; G05B 13/02

(52) U.S. Cl. CPC G05B 13/048; G05B 13/0265; G05B 13/042

(57) ABSTRACT

A method for use in manufacturing a material having a value for a first measurable material property in a pre-determined range of values is disclosed, the method comprising obtaining a first set of input parameters; predicting or triggering predicting a value for the first measurable material property of a material based on the obtained first set of input parameters using a predictive model trained based on a stored plurality of data sets; and determining or triggering determining, at least based on the predicted value for the first measurable material property, a second set of input parameters for manufacturing a material. A corresponding method for use in manufacturing a material having a value for a first measurable material property in a pre-determined range of values comprising training the predictive model is disclosed. Additionally, a corresponding system, corresponding apparatuses and corresponding computer programs are disclosed.

### CROSS-REFERENCE TO RELATED APPLICATION

This application is a U.S. National-Stage entry under 35 U.S.C. § 371 based on International Application No. PCT/EP2022/083632, filed Nov. 29, 2022, which was published under PCT Article 21(2) and which claims priority to U.S. Provisional Application No. 63/290,792, filed Dec. 17, 2021, which are all hereby incorporated in their entirety by reference.

### TECHNICAL FIELD

The present disclosure relates to methods, apparatuses, systems, computer programs and tangible, non-transitory computer-readable mediums storing a computer program code, each for use in manufacturing a material having a value for a first measurable material property in a pre-determined range of values.

### BACKGROUND

A material having specific properties may be desirable or even needed for specific applications. Such specific properties may be measurable and a specification may indicate a pre-determined range of acceptable values for the specific material property. However, it may not always be known how to manufacture a material having the specified material property. Therefore, series of experiments may be used to determine a formulation, i.e. a set of input parameters, which can be used to manufacture a material meeting the requirements. The design of such experiment series may be guided by an expert's intuition and experience. In some scenarios, this may quickly result in a formulation that delivers a material with the desired properties. In contrast, in other scenarios, experiment series may be time-consuming as a large number of experiments may be required. Additionally, such experiment series may be potentially using many resources, for instance in terms of input material.

Digital tools supporting laboratory work such as “Albert” enable the storage of experimental data and easy access thereto. Such tools can benefit from further functionalities.

It is inter alia an objective of the example embodiments described in the following to overcome one or more of the disadvantages stated above, preserve one or more advantages stated above, and/or improve and/or adapt one or more of the technologies described above.

### BRIEF SUMMARY

According to a first example embodiment, a method for use in manufacturing a material having a value for a first measurable material property in a pre-determined range of values is disclosed, and the method comprises obtaining a first set of input parameters, and predicting or triggering predicting a value for the first measurable material property of a material based on the obtained first set of input parameters using a predictive model trained based on a stored plurality of data sets. The one or more data sets of the plurality of data sets comprise respective measured values for the first measurable material property. Each data set of the plurality of data sets is associated with a respective manufactured material of a plurality of manufactured materials in that the data set comprises respective input parameters, in particular input material parameters and/or process parameters, based on which the respective material was manufactured. The data set comprises respective measured one or more values of respective one or more material properties of the respective manufactured material. The method also includes determining or triggering determining, at least based on the predicted value for the first measurable material property, a second set of input parameters for manufacturing a material.

According to a second example embodiment, a method for use in manufacturing a material having a value for a first measurable material property in a pre-determined range of values is disclosed, and the method comprises obtaining a plurality of data sets. Each data set of the plurality of data sets is associated with a respective manufactured material of a plurality of manufactured materials in that the data set comprises respective input parameters, in particular input material parameters and/or process parameters, based on which the respective material was manufactured. The data set comprises respective measured one or more values of respective one or more material properties of the respective manufactured material. One or more data sets of the plurality of data sets comprise respective measured values for the first measurable material property. The method includes storing the plurality of data sets, and training, based on the stored plurality of data sets, a predictive model for predicting a value for the first measurable material property of a material based on a first set of input parameters.

### BRIEF DESCRIPTION OF THE DRAWINGS

It is shown in:

FIG. 1 is a schematic block diagram of a system according to an example embodiment;

FIG. 2 is a flowchart showing an example embodiment of the method according to the first example aspect;

FIG. 3 is a flowchart showing an example embodiment of the method according to the second example aspect;

FIG. 4 is a schematic user interface of an apparatus according to an embodiment of the first and/or second example aspect; and

FIG. 5 is a schematic block diagram of an apparatus according to the first or second example aspect.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

In example embodiments, the methods of the first and second example embodiments (or here aspects) may be combined. Thus, the method according to the first example aspect may comprise some or all actions described with respect to the method according to the second example aspect. Similarly, the method according to the second example aspect may comprise some or all actions described with respect to the method according to the first example aspect.

Furthermore, the following shall be disclosed for each of the two example aspects:

(1) An apparatus or system configured to perform and/or control or comprising respective features for performing and/or controlling the method according to the respective aspect of the present disclosure.

The employing of the apparatus or system can be implemented in hardware and/or software. They may comprise for instance at least one processor for executing computer program code for performing the required function, at least one memory storing the program code and/or data, or both. Alternatively, they could comprise for instance circuitry that is designed to implement the required functions, for instance implemented in a chipset or a chip, like an integrated circuit. In general, the employment may comprise for instance one or more processing features or processors.

(2) An apparatus or system (that in particular comprises at least two apparatuses) comprising at least one processor and at least one memory including computer program code, the at least one memory and the computer program code configured to, with the at least one processor, cause an apparatus or system (e.g. the apparatus or the system) at least to perform and/or control the method according to the respective aspect of the present disclosure.

The disclosed apparatus performing the method according to the respective aspect of the present disclosure may comprise only the disclosed components (e.g. employment, processor, memory) or may further comprise one or more additional components.

(3) A computer program when executed by a processor causing an apparatus to perform and/or control the actions of the method according to the respective example aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory (e.g. a Read-Only Memory (ROM) or hard disk of a computer), or be intended for distribution of the program, like an optical disc.

(4) A tangible, non-transitory computer-readable medium storing a computer program code, the computer program code when executed by a processor causing an apparatus to perform and/or control the method according to the respective example aspect.

In the following, example details and further embodiments according to the first and/or second example aspect introduced above will be described. The example details and further embodiments shall be understood to be equally disclosed for the method, apparatuses/systems, computer program and computer-readable medium of each of these aspects, respectively.

The methods according to the first or second aspect are for use in manufacturing a material. Such a manufacturing process may be defined by a set of input parameters, e.g. input material parameters and/or process parameters. Input material parameters may define a quantity and/or quality of one or more materials that are used or input in the manufacturing process. Process parameters may define how the manufacturing is done, e.g. at what temperature.

Depending on one or more of these input parameters to the manufacturing process, properties of the manufactured material may change. Thus, the input parameters may be adapted to change the properties of the manufactured material. The aim may be to find input parameters which when used in the manufacturing of a material result in a material having one or more desired material properties.

The methods according to the first or second aspect are used for manufacturing a material having a value for a first measurable material property in a pre-determined range of values. The pre-determined range of values may define the desired material property. The range may be defined by an upper threshold. Alternatively or additionally, it may be defined by a lower threshold. The range may comprise only one value or a plurality of values. The values may be continuous numbers, integers, Booleans or they may be given in any other format.

Examples of the first measurable material property are strain at break, stress at break, heat deflection temperature (HDT), e.g. via dynamic mechanical analysis (DMA), e.g. for 0.455 MPa and/or fully cured, Young's modulus, impact strength or hysteresis. However, the methods according to the first or second example aspect may also be used for any other measurable material property.

Given a material, a value for a first material property may be determinable, for instance by measurements. Thus, a material might be manufactured based on a first set of input parameters and a value for the first measurable material property of the material may be measured. This process may be repeated to observe the changes in the value for the first measurable material property of a manufactured material when changing the first set of input parameters for the manufacturing of the material. The observations may be used to find input parameters for manufacturing a material that has a value for the first measurable material property in a pre-determined range of values.

However, instead of manufacturing a material each time to measure the value for the first measurable material property of the material, the value for the first measurable material property of a material may be predicted. For instance, in a series of manufacturing processes, each having a different set of input parameters, one or more manufacturing process could be replaced by a prediction according to the methods of the first or second example aspect.

More specifically, the method according to the first example aspect comprises obtaining a first set of input parameters. This first set of input parameters may partially or fully define the manufacturing process of a material, e.g. in terms of input material parameters and process parameters. It may be obtained for example in that it is scanned, received, retrieved or output from an apparatus. Alternatively, it may be obtained for instance by user input.

Further, the method according to the first example aspect comprises predicting or triggering predicting a value for the first measurable material property of a material based on the obtained first set of input parameters. Whether the value for the first measurable material property is predicted or whether the predicting is triggered may depend on the apparatus that performs the method according to the first example aspect and the apparatus that performs the predicting. For example, the method according to the first example aspect may be performed by a first apparatus, e.g. a personal computer of a user in a laboratory. The prediction may then be done by the first apparatus. In other embodiments, it might instead be done by a server, e.g. a cloud. In this case the first apparatus, e.g. the personal computer, may trigger the prediction, e.g. by requesting it from the server. In another embodiment, however, an apparatus such as a server may perform the method according to the first example aspect. It may then do the prediction itself.

The value for the first measurable material property of a material is predicted based on the obtained first set of input parameters using a predictive model. The predictive model may have been trained based on a stored plurality of data sets, e.g. before the start of the method according to the first example aspect. At the time of training, the one or more data sets of the plurality of data sets comprise respective measured values for the first measurable material property. Each data set of the plurality of data sets is associated with a respective manufactured material of the plurality of manufactured materials in that the data set comprises respective input parameters, in particular input material parameters and/or process parameters, based on which the respective material was manufactured, and the data set comprises respective measured one or more values of respective one or more material properties of the respective manufactured material. Thus, a respective association may be given by the fact that the respective data set comprises the respective input parameters on which the respective material was manufactured and the respective measured one or more values of the respective one or more material properties of the respective manufactured material. However, it is to be understood that such an association may take various forms. Therefore, a respective association may comprise further connections between the respective data set and the respective manufactured material.

It can be seen that the predictive model is or has been trained based on data that is related to previously conducted manufacturing processes. Accordingly, at least in some embodiments, the predictive model is not based on a direct algebraic modelling of physical and/or chemical processes. In various embodiments, this principle may result in the advantage of the predictive model to be useable in the context of various sets of input parameters and/or measurable material properties, e.g. without adapting the predictive model to specific models for algebraic modelling of physical and/or chemical processes.

In various embodiments, the predictive model may be a machine learning model, e.g. a supervised learning model. Thus, data sets of the stored plurality of data sets may have been divided at least into a group of training data sets and a group of test data sets for training.

The predictive model may relate to only the first measurable material property such that values for this first measurable material property can be predicted using the predictive model. Thus, a single predictive model may in particular not relate to or be used to predict values for further first measurable material properties. Instead, one predictive model may be trained per one first measurable material property. Thus, for predicting respective values for multiple first measurable material properties multiple predictive models may be trained, respectively.

Furthermore, the predictive model may be a model for regression, e.g. a model for Bayesian linear regression or a Gaussian process for regression. As compared to models that are based on neural networks, regression models may have the advantage that they require less input data sets for training. This may be particularly beneficial considering that manufacturing processes used to generate data sets for training may be expensive in terms of resources, e.g. time and/or input material.

The data sets may be stored and/or processed in any suitable format, in particular electronically and/or in machine-readable format. For instance, a data set may be represented as a table or part of table. However, it may also represented as a structure or an object of a programming language. The data sets may be stored locally, e.g. on the apparatus that trained the predictive model, and/or remotely, e.g. on an apparatus with which the apparatus that trained the predictive model is able to communicate.

The method according to the first example aspect further comprises determining or triggering determining, at least based on the predicted value for the first measurable material property, a second set of input parameters for manufacturing a material. In various embodiments, the predicted value for the first measurable material property may be compared to the pre-determined range of values for the first measurable material property. Depending on the result of the comparison, the second set of input parameters may be determined.

Let us consider the following simple example of this principle. First, a material is manufactured based on a set of input parameters (set 0). A value is measured for the first measurable material property of the manufactured material. It is found that the value lies outside the pre-determined range of, e.g. desired, values. In consequence, a first set of input parameters is determined which is different from set 0). The aim is to find a set of input parameters that allows the manufacturing of a material that has a value for the first measurable material property in the pre-determined range of values. As an example, it is assumed that a quantity of material A as input is defined to be increased in the first set of input parameters as compared to set 0). The first set of input parameters is fed to an apparatus so that the apparatus obtains the first set. The apparatus predicts or triggers the predicting of a value for the first measurable material property of a material based on the obtained first set of input parameters using a predictive model, as described above. However, by way of example, the predicted value may lie even farther outside the pre-determined range of values for the first measurable material property. Thus, at least based on the predicted value for the first measurable material property, a second set of input parameters may be determined. In the given example, the quantity of material A as input is decreased in the second set of input parameters as compared to the first set of input parameters. The aim may be to specify a set of input parameters based on which a material may be manufactured that has a value that is closer to the pre-determined range of values for the first measurable material property than the material that was manufactured or predicted based on the first set of input parameters.

Whether the second set of input parameters is determined or whether the determining is triggered may depend on the apparatus that performs the method according to the first example aspect and the entity that performs the determining. For example, the method according to the first example aspect may be performed by a first apparatus, e.g. a personal computer, e.g. of a user, e.g. in a laboratory. The determining may then be done by the first apparatus. However, it might instead be done by a server, e.g. a cloud. In this case the first apparatus, e.g. the personal computer, may trigger the determining, e.g. by requesting it from the server. In another embodiment, however, a user may perform the determining of the second set of input parameters. Accordingly, the determining of the second set of input parameters for manufacturing a material at least based on the predicted value for the first measurable material property may be triggered by outputting the predicted value for the first measurable material property, e.g. to the user, e.g. via a screen, a printer or any other interface.

On the one hand, it may be beneficial to have an apparatus determine a second set of input parameters for manufacturing a material at least based on the predicted value for the first measurable material property, e.g. to save time. On the other hand, it may be beneficial to trigger a user to determine at least based on the predicted value for the first measurable material property a second set of input parameters for manufacturing a material. This may be especially true for an experienced user that may be able to determine a better second set of input parameters. In this context, better may be understood to mean that a material manufactured according to the second set of input parameters has a value that is closer to the pre-determined range of values for the first measurable material property than a material manufactured according to another second set of input parameters.

In addition to the method according to the first example aspect, a method according to a second example aspect is disclosed. For conciseness, the description with respect to the method according to the first example aspect is to be understood to also apply with respect to the method according to the second example aspect. Furthermore, it is to be understood that some or all actions of the methods of the first and the second example aspect may be combined in a method.

The method according to the second example aspect comprises training, based on a stored plurality of data sets, a predictive model for predicting a value for the first measurable material property of a material based on a first set of input parameters. As described with respect to the method according to the first example aspect, the predictive model may be a machine learning model, e.g. a supervised learning model and in particular for instance a regression model.

For training, based on a stored plurality of data sets, a predictive model, a plurality of data sets is needed. Therefore, the method according to the second example aspect comprises obtaining a plurality of data sets and storing the plurality of data sets. Each data set of the plurality of data sets is associated with a respective manufactured material of a plurality of manufactured materials in that the data set comprises respective input parameters, in particular input material parameters and/or process parameters, based on which the respective material was manufactured. Furthermore, the data set comprises respective measured one or more values of respective one or more material properties of the respective manufactured material and one or more data sets of the plurality of data sets comprise respective measured values for the first measurable material property.

The obtaining and storing of the plurality of data sets may or may not correspond to two distinct steps. For instance, a plurality of data sets may be received e.g. at essentially the same time e.g. from the same apparatus. The plurality of data sets may then be stored. On the other hand, it is also possible that one data set after another may be obtained and stored, thus forming the plurality of data sets that is obtained and stored.

A data set may be obtained for example by way of receiving or retrieving information from another apparatus, e.g. using the Internet, or e.g. scanning e.g. output from an apparatus. Alternatively, a data set may be obtained for instance by user input. All data sets of the plurality of data sets may be obtained in the same manner. However, this is not needed and one or more data sets of the plurality of data sets may be obtained in different manners.

In various embodiments, an apparatus, e.g. a server, performs the method according to the second example aspect. It may obtain the data sets of the plurality of data sets from a plurality of different apparatuses. For instance, it may collect data from apparatus that are associated with a plurality of users and/or respective laboratories. This may be beneficial as it may help to increase the number of data sets in the plurality of data sets. As a consequence, it may be possible in various embodiments that more data sets may be used for training the predictive model than when data is obtained or collected only from one or more apparatuses that are associated with e.g. a limited number of laboratories, e.g. 1.

Obtaining data from a plurality of users and/or respective laboratories may under various circumstances have non-ideal effects due to lacking harmonization. Accordingly, in various embodiments of the method according to the second example aspect, wherein the plurality of data sets is obtained from a plurality of apparatuses, the method further comprises: providing, to the plurality of apparatuses, information for harmonizing input parameters relating to a same type of input. Therein, the providing may be done in various manners, e.g. by providing a platform for access like a website or e.g. by sending the information e.g. via the Internet to the plurality of apparatuses.

The information for harmonizing input parameters relating to a same type of input may for example be a list of input parameters. The input parameter “temperature” may for instance be on the list as an example for a process parameter. Thus, the plurality of apparatuses that receive this information may e.g. prompt a user to enter data for the input parameter “temperature” when creating a data set. In addition to a list of input parameters that are to be used, the information for harmonizing input parameters may comprise a list of undesired input parameters that are similar to the input parameter that is to be used. For example, the list of input parameters may comprise the input parameter “temperature” as an input parameter to be used and may further comprise the input parameters “heating” and “temp.” as input parameters that are not to be used. Apparatuses of the plurality of apparatuses from which the plurality of data sets is obtained may thus use the same input parameter, e.g. by replacing and/or converting e.g. their respective input parameters “heating” to the input parameter “temperature”. Using harmonized input parameters in training a predictive model may significantly improve the prediction capabilities of the predictive model.

Additionally or alternatively, in various embodiments, the method according to the first and/or second example aspect may comprise the following: identifying two or more data sets of the plurality of data sets, wherein at least one data set of the two or more data sets comprises a first input parameter, wherein at least one other data set of the two or more data sets comprises a different first input parameter, and wherein both first input parameters relate to a same type of input; and determining a harmonized first input parameter for the two or more data sets for use in training of the predictive model. Thus, while in the previous paragraph it was described that a plurality of apparatuses contribute to harmonizing input parameters, in this paragraph it is described that the apparatus performing the method according to the first or second example aspect harmonizes input parameters. A similar example as above may be considered. That is to say, the first input parameter may be “temperature in Celsius”. The different first input parameter may be “heating in Kelvin”. Both input parameters may relate to a same type of input, e.g. temperature. Thus, a harmonized first input parameter might be “temperature in Kelvin” and both first input parameters may be converted accordingly.

The identification of the two or more data sets of the plurality of data sets, wherein at least one data set of the two or more data sets comprises a first input parameter, wherein at least one other data set of the two or more data sets comprises a different first input parameter, and wherein both first input parameters relate to a same type of input may be done e.g. based on the respective units and/or respective labels of the input parameters. For instance, two data sets may be identified based on the fact that one of the two data sets comprises a first input parameter having a unit of Celsius and the other of the two data sets comprises a different first input parameter, e.g. having a different label, but also having a unit of Celsius. Additionally or alternatively, two data sets may be identified based on the fact that one of the two data sets comprises a first input parameter being labelled in a first manner, e.g. “temp.” and the other of the two data sets comprises a different first input parameter which is, however, labelled in a related manner, e.g. “temperature”. As described before, using harmonized input parameters in training a predictive model may significantly improve the prediction capabilities of the predictive model.

The approach described above may be considered to be an example of a feature engineering approach. Similar approaches may be performed not only in order to harmonize input parameters, but to derive features, e.g. such that the method comprises: identifying two or more data sets of the plurality of data sets, wherein at least one data set of the two or more data sets comprises a first input parameter, wherein at least one other data set of the two or more data sets comprises a different first input parameter; and determining a derived first input parameter based on the two or more data sets for use in training of the predictive model. The derived first input parameter may for instance be determined by using calculations based on the first input parameter and the different first input parameter, e.g. by adding or multiplying them. However, in alternative embodiments, no derived features are used in the training of the predictive model.

As described above, the method according to the first or second example aspect may be performed by one apparatus, respectively. This apparatus may e.g. be a server, the term “server” being understood to comprise also a cloud or a server network. Alternatively, the apparatus may be e.g. a personal computer or any other electronic device, e.g. a laptop, a smartphone or a tablet.

However, as also described above, the method according to the first or second example aspect may be performed by more than one apparatus, e.g. multiple apparatus or a combination of an apparatus and a user, i.e. a human being. In various embodiments, an apparatus or a system may perform the method according to the first and the second example aspect. The apparatus may for instance be a server; the system may for instance comprise a server and a further electronic device.

In the following, further example details of example embodiments of the method according to the first and/or second example aspect are described. It is to be understood that embodiments of the methods according to any of the example aspects may comprise any combination of the example details described below.

In various embodiments of the method according to the first example aspect, the determining of the second set of input parameters for manufacturing the material may be triggered by outputting the predicted value for the first measurable material property. For example, the determining may be triggered by outputting the predicted value to a user, e.g. an expert in the field, that determines the second set of input parameters for manufacturing the material. The outputting may then correspond, for instance, to displaying the predicted value on a screen, outputting the predicted value audibly or printing the predicted value on a piece of paper. Additionally or alternatively, the determining of the second set of input parameters for manufacturing the material may be triggered by outputting the predicted value to an apparatus, e.g. via the Internet or any other wired or wireless communication link. The other apparatus that receives, scans or obtains the predicted value may then determine the second set of input parameters.

Further, in various embodiments the method according to the first example aspect may comprise determining or triggering determining an uncertainty that relates to the predicted value. The uncertainty may be a measure that is determined or computed according to pre-defined rules. Comparing two or more uncertainties determined according to the same pre-defined rules may allow to determine which of the respective related predicted values is more likely to be correct and/or closer to the correct value. An example measure of an uncertainty could be a standard deviation or variance of a prediction or of the predictive model. However, there may be different pre-defined rules for determining an uncertainty and comparing uncertainties determined according to different pre-defined rules may not allow the conclusion which of the respective related predicted values is more likely to be correct and/or closer to the correct value. Furthermore, an uncertainty may be a continuous or discrete value. Additionally or alternatively, it may also be e.g. a binary value such as “1” or “0” or “TRUE” or “FALSE”.

In various embodiments of the method according to the first example aspect, the uncertainty is determined based on the obtained first set of input parameters and the stored plurality of data sets. Thus, the uncertainty may not or not only be determined based on a standard deviation or variance of the prediction or the predictive model. Instead, it may for instance be possible to filter the stored plurality of data sets for one or more input parameters of the obtained first set of input parameters and/or combinations thereof. Then, for example, if there is no data set in the stored plurality of data sets that is associated with one, some, or all input parameters of the obtained first set of input parameters, it may be determined that there is uncertainty, e.g. the uncertainty may be “TRUE” or correspond to a, e.g. high, value. In contrast, if there are one or more data sets in the stored plurality of data sets that are associated with e.g. some or e.g. all or e.g. a pre-determined number of input parameters of the obtained first set of input parameters, the uncertainty may be “FALSE” or correspond to another, e.g. low; value.

The determined uncertainty may be taken into account in further steps. For example, in various embodiments of the method according to the first example aspect, the second set of input parameters may be further based on the determined uncertainty. For instance, if the uncertainty is e.g. “TRUE” and/or outside a pre-determined range of values, the second set of input parameters may be determined to be partially or fully identical or similar to the first set of input parameters. The idea may be to manufacture a material based on the second (in this example corresponding to the first) set of input parameters since the uncertainty related to the predicted value was e.g. high, e.g. “TRUE” or e.g. outside a pre-determined range of values. In contrast, if the uncertainty is e.g. “FALSE” or inside a pre-determined range of values, the second set of input parameters may be determined to be partially or fully different from the first set of input parameters.

In various embodiments of the method according to the first example aspect, the determining of the second set of input parameters for manufacturing the material is not triggered and/or performed if the uncertainty lies outside a predetermined range of one or more values. The predetermined range of one or more values may correspond to a closed or open interval of continuous or discrete numbers. Additionally or alternatively, the predetermined range of one or more values may be a single value, e.g. a binary value such as “TRUE” or “FALSE” or “0” or “1”. Not triggering or performing the determining of the second set of input parameters for manufacturing the material may be beneficial in that it may avoid the determination of a second set of input parameters based on a predicted value which is not trusted.

In various embodiments of the method according to the first example aspect, the uncertainty lies outside the predetermined range of one or more values if the first set of input parameters comprises a parameter for which there are less than a predetermined number of data sets in the stored plurality of data sets that comprise this parameter as an input parameter. For instance, if the first set of input parameters comprises a parameter for which there are less than a predetermined number of data sets in the stored plurality of data sets that comprise this parameter as an input parameter, the uncertainty may be set or determined to be a value that is, by definition, outside the predetermined range of the one or more values. Thus, in various embodiments, the determining of the second set of input parameters for manufacturing the material will not be triggered and/or performed if the first set of input parameters comprises a parameter for which there are less than a predetermined number of data sets in the stored plurality of data sets that comprise this parameter as an input parameter.

Further, in various embodiments of the method according to the first example aspect, the first set of input parameters is obtained by or in reaction to a user input. For example, a user may enter or select the first set of input parameters using a user interface of an apparatus performing the method according to the first example aspect. Thereby, the apparatus obtains the first set of input parameters. Alternatively or additionally, a user may trigger the apparatus to request the first set of input parameters from another apparatus. The apparatus may obtain the first set of input parameters from the other apparatus in reaction to the request and, thus, in reaction to the user input.

In various embodiments of the method according to the first example aspect, the method according to the first example aspect is performed iteratively and/or repeatedly. For instance, in a series of. e.g. experimental, manufacturing processes to find a set of input parameters to manufacture a material having a value for a first measurable material property in a pre-determined range of values, several of the physical manufacturing processes may be replaced by the method according to the first example aspect. Given that is the case, the first set of input parameters of an iteration may correspond to the second set of input parameters of a preceding iteration. For example, a user may be triggered to determine, at least based on the predicted value for the first measurable material property, a second set of input parameters for manufacturing a material. e.g. via an output on a screen of an apparatus. The user may then determine the second set of input parameters and enter it into the apparatus as the first set of input parameters of the next iteration. Alternatively, the apparatus itself may determine the second set of input parameters. e.g. according to pre-defined rules, thereby obtaining the first set of input parameters of the next iteration. Thanks to the iterative procedure it may be possible that the set of input parameters is efficiently developed to find input parameters for manufacturing a material having a value for a first measurable material property in a pre-determined range of values.

Further, in various embodiments the method according to the first example aspect may comprise manufacturing or triggering manufacturing a material based on the first or second set of input parameters. For instance, the value predicted based on the first set of input parameters for the first measurable material property of a material may lie in the pre-determined range of values. e.g. the range that is desired for a material. Consequently, the material may be manufactured using this set of input parameters. This set of input parameters may be understood not only to be the first set of input parameters, but also the partially or fully identical determined second set of input parameters. However, a material may also be manufactured based on the first or second set of input parameters in other scenarios; for instance because in a series of experimental manufacturing processes, some manufacturing processes may be replaced by predictions whereas other manufacturing processes are still carried out.

Additionally, in various embodiments the method according to the first example aspect may comprise measuring a value of or obtaining a measured value of the first measurable material property of the material manufactured based on the first or second set of input parameters, and providing the measured value for use in training of a predictive model. Accordingly, in various embodiments the method according to the second example aspect may comprise obtaining a measured value of the first measurable material property of the material manufactured based on the first set of input parameters, and using the measured value in training the predictive model. For example, a user or a measurement device may measure a value of the first measurable material property of the material manufactured based on the first or second set of input parameters. An apparatus that performs the method according to the first example aspect may then obtain the measured value, e.g. from the user or the measurement device. Next, the apparatus may provide the measured value for use in training of a predictive model, e.g. to another apparatus. The other apparatus may be e.g. an apparatus that performs the method according to the second example aspect which obtains the measured value and uses it in training the predictive model. The providing and corresponding obtaining may for instance be done e.g. electronically, e.g. using the Internet.

In various embodiments of the method according to the first or second example aspect, the training of the predictive model and/or the predicting of the value for the first measurable material property of a material based on the obtained first set of input parameters using the predictive model is done using a server. Using the server in this context may be understood to comprise the case that a request is sent to the server and the server acts accordingly. However, it may also be understood to comprise the case that there is a collaboration between an apparatus that performs the method according to the first or second example aspect and the server. Such a collaboration may imply that e.g. tasks are shared or that pieces of information are exchanged. Using the server may have the advantage that multiple apparatus may use the server, e.g. the server may only do one training or prediction and multiple apparatus may use the resulting predictive model or predicted value. In various embodiments, the server may be an apparatus that performs the method according to the second example aspect.

Further, in various embodiments of the method according to the second example aspect, the training of the predictive model in which the measured value is used is an incremental or sequential training. For instance, an apparatus receives a plurality of measured values, comprising the measured value referred to in the previous sentence. For example after a pre-determined time, some or all measured values of the plurality of received measured values are used to update the predictive model, without using all data sets of the plurality of data sets that was previously used to train the predictive model.

It is to be understood that, in various embodiments the method according to the second example aspect may be performed iteratively and/or repeatedly. This may be beneficial in that the predictive model is not only trained once, but that other or further values are used as the basis for the training of the predictive model. In various embodiments, both the method according to the first example aspect and the method according to the second example aspect may be performed iteratively and/or repeatedly, respectively. The iterations or repetitions may be synchronous but this is not necessarily the case. For example, in a pre-defined time interval there could be several iterations or repetitions of the method according to the first example aspect while there is only one iteration or repetition of the method according to the second example aspect. By way of example, the method according to the second example aspect could be retrained every hour, every day, every week, every month or every year or anything less than that, greater than that or in between.

In various embodiments of the method according to the first or second example aspect, the stored plurality of data sets is sparse with respect to one or more input parameters. A matrix or an array may be considered to be sparse if most of its elements are zero. The number of zero-valued elements divided by the total number of elements (e.g., m×n for an m×n matrix) is sometimes referred to as the sparsity of the matrix. In this context, a criterion for assessing whether a matrix is sparse may be to determine whether its sparsity is e.g. above 50%, above 60%, above 70%, above 75%, above 80% or above 90%.

In various embodiments, the stored plurality of data sets may even be considered to be “too” sparse with respect to one or more input parameters. Thus, in various embodiments one or more input parameters are disregarded in the training of the predictive model, in case the number of data sets for the training of the predictive model comprising the one or more input parameters is less than or equal to a predetermined number. For example, a situation may occur in which there is only one data set which comprises a specific input parameter. It may be decided to disregard this input parameter in the training of the predictive model. Then, the predetermined number is e.g. 1. However, the predetermined number may be any other number, e.g. 0 or any other positive integer.

Disregarding features as described above may be done based on the following observations. Disregarding an input parameter may decrease the number of input parameters and, thus, the complexity of the training. At the same time, having a limited number of data sets, e.g. less than or equal to a predetermined number, which comprises the specific input parameter may, e.g. under some circumstances, not be sufficient to enable a reliable training and/or prediction with respect to this input parameter anyway. Further, it has been observed that under various circumstances more complex procedures to decrease the number of input parameters, e.g. like component analysis, may lead to worse predictions or prediction capabilities of the predictive model than the, under various circumstances, computationally more efficient procedure described above.

In various embodiments, the method according to the second example aspect further comprises selecting a subset of the plurality of data sets based on the respective one or more material properties of the respective manufactured material of which the respective data set of the plurality of data sets comprises respective measured one or more values, wherein data sets of the plurality of data sets that are not part of the selected subset are disregarded in the training of the predictive model. This may have the effect that the number of input parameters for training the predictive model and, thus, the complexity of the training is reduced.

For example, the predictive model may be trained to predict a value for a first measurable material property, e.g. tensile strength. The plurality of data sets may comprise various data sets that do not relate to the exemplary measurable material property “tensile strength”, but relate to one or more other measurable material properties, e.g. “strain at break”. Accordingly, a subset may be selected from the plurality of data sets such that, for instance, the subset only comprises data sets which relate to the measurable material property “tensile strength”. Some or all data sets of the subset may then be used for the training of the predictive model whereas e.g. other data sets of the plurality of data sets are not used for the training. It is understood that for another predictive model, e.g. relating to a different measurable material property, a different subset may be selected.

As described above, in various embodiments of the methods according to the first or second example aspect, the predictive model is a regression model. A regression model may be understood to refer to a model that predicts a value of a target variable, e.g. a first measurable material property of a material, given the value of one or more input variables, e.g. a first set of input parameters.

A very simple example of a regression model may be a linear model for regression. Therein, a value y is predicted from a vector of input variables x=(x₁, . . . , x_{D})^{T} using the model parameters w=(w₀, . . . , w_{M-1})^{T}, i.e.

$$y ( x , w ) = {\sum }_{j = 1}^{M - 1} {w}_{j} {φ}_{j} ( x ) = {w}^{T} Φ ( x )$$

where φⱼ(x) are known as basis functions and Φ=(φ₀, . . . , φ_{M-1})^{T}, where the dependence on x has been omitted for an uncluttered notation. A very simple example of basis functions could be polynomials, i.e. φⱼ(x)=x^{j}. Furthermore, in a very simple example the parameters w could be determined, i.e. trained, by maximum likelihood, i.e.

$${w}_{ML} = {( {Φ}^{T} Φ )}^{- 1} {Φ}^{T} t$$

where t is a vector of values of the target variable observed for the input variables x. It is to be understood that more complex models may be used in various embodiments of methods according to the first or second example aspect.

In the following, a more detailed description of example embodiments will be provided with reference to drawings.

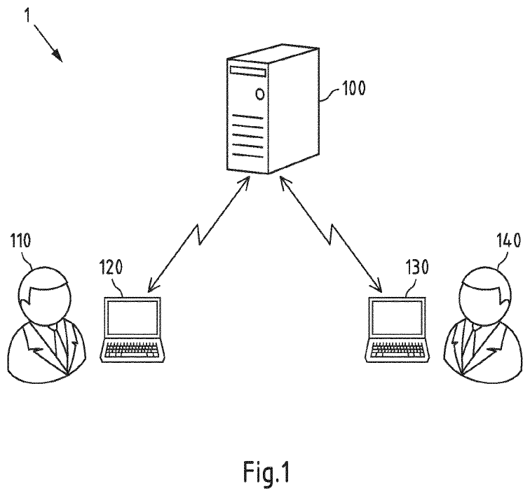

FIG. 1 shows a schematic block diagram of a system 1 according to an example embodiment.

The system 1 comprises a server 100. Further, by way of example, the system 1 comprises an electronic device 120, e.g. a laptop, and a further electronic device 130, which may also be a laptop. It is to be understood that the number of apparatuses in the system 1 is merely an example and may be greater or less than what is shown in FIG. 1. Apart from the apparatuses, FIG. 1 also shows users 110 and 140. User 110 may be a user of electronic device 120 and user 140 may be a user of electronic device 130. One or both users 110, 140 may be experts, e.g. chemists, that aim at manufacturing a material having a value for a first measurable material property in a pre-determined range of values. As an example only, stress at break will be considered as the first measurable material property in the following. However, in other embodiments, it may be any other measurable material property.

Each of the electronic device 120, 130 may be configured to communicate with the server 100, e.g. via the Internet. Further, each of the electronic devices 120, 130 may have a respective user interface to interact with the users 110, 140, respectively. Such a user interface may for instance be a screen and a keyboard and/or a touchscreen.

The user 110 and their electronic device 120 may be associated with a first laboratory. The user 130 and their electronic device 140 may be associated with the same or a different second laboratory. The electronic devices 130, 140 may be connected to respective lab equipment, e.g. for performing measurements.

Each of the apparatus, i.e. the server 100 and the electronic devices 120, 130, may be configured to perform the method according to the first and/or the second example aspect. Against this background, the embodiment described in the following is merely to be understood as an example. Any of the steps described below may be performed by any of the apparatuses 100, 120, 130, or even by one or more further apparatus that are not shown in FIG. 1.

Anything described with respect to the first user 110 and their electronic device 120 may additionally or alternatively done by further users and electronic devices, e.g. user 140 and electronic device 130. Using a server 100 to provide functions and services for a plurality of clients, e.g. electronic devices 120, 130 and their users 110, 140, may be efficient in that some actions only have to be performed once instead of multiple times, e.g. training of a predictive model. Similarly, collecting multiple data sets from multiple entities may be beneficial in training the predictive model.

In the specific example embodiment considered here, the apparatus 120 is configured to perform the method according to the first example aspect and the server 100 is configured to perform the method according to the second example aspect. Accordingly, the server 100 obtains a plurality of data sets, wherein each data set of the plurality of data sets is associated with a respective manufactured material of a plurality of manufactured materials in that the data set comprises respective input parameters, in particular input material parameters and/or process parameters, based on which the respective material was manufactured, and the data set comprises respective measured one or more values of respective one or more material properties of the respective manufactured material, wherein one or more data sets of the plurality of data sets comprise respective measured values for the first measurable material property, e.g. stress at break.

The server 100 may obtain the data sets of the plurality of data sets from different origins, e.g. electronic devices 120, 130. For instance, user 110 may have manufactured one or more materials based on respective input parameters. They may have measured one or more values of respective one or more material properties of the respective manufactured material. For at least some materials, they may have measured values for the first measurable material property, e.g. stress at break. Further, the user 110 may have fed information to the electronic device 120 so that a data set for each of the plurality of manufactured materials was generated. This could happen locally at the electronic device 120. Next, the plurality of data sets could be sent from the electronic device 120, e.g. via the Internet, to the server 100. Consequently, the server 100 may obtain the data sets from the electronic device 120. An analogous procedure could be performed by the user 140 using the electronic device 130.

The server 100 stores the plurality of data sets and trains, based on the stored plurality of data sets, a predictive model for predicting a value for the first measurable material property, e.g. stress at break, of a material based on a first set of input parameters. The storing and/or training could be done by the server 100. However, it may also happen e.g. in a collaboration of the server 100 with e.g. one or more further servers.

Furthermore, at the time of training the predictive model, the specific first set of input parameters and the specific first measurable material property for predicting a value need not yet be defined. Instead, the server 100 may train the predictive model such that it can predict a value for various possible first measurable material properties and various possible first sets of input parameters. Once the predictive model is trained, the server 100 may be able to predict a value for a first measurable material property of a material based on an obtained first set of input parameters using the predictive model.

It is noted that generally, there may be a large number of possible different sets of input parameters and a large number of measurable material properties. Thus, it is likely that in practice, there are many combinations of input parameters and measurable material properties for which there are no or only few data sets in the plurality of data sets available. Consequently, the stored plurality of data sets may be considered to be sparse with respect to one or more of these input parameters. As a consequence, a regression model may be used as a predictive model to adapt to these conditions.

As explained above, user 110 aims at manufacturing a material having a value for a first measurable material property. e.g. stress at break, in a pre-determined range of values. To that end, user 110 may have manufactured one or more materials based on respective input parameters and measured respective values of the first measurable material property, e.g. stress at break, for the respective manufactured materials. However, instead of manufacturing another material based on a first set of input parameters, user 110 may enter the first set of input parameters into the electronic device 120, e.g. in a program running on the electronic device 120, to cause a prediction of a value for the first measurable material property. e.g. stress at break, for the entered first set of input parameters. Thus, the electronic device 120 obtains the first set of input parameters and triggers the server 100, e.g. by an electronic request, to predict a value for the first measurable material property of a material based on the obtained first set of input parameters. The server 100 may use the predictive model that was previously trained, as described above, for predicting the value. Next, the server 100 may send the predicted value to the electronic device 120. The electronic device 120 outputs the predicted value on its screen. It thereby triggers the user 110 to determine, at least based on the predicted value for the first measurable material property, a second set of input parameters for manufacturing a material. For example, if the output predicted value lies in the pre-determined range of values that the material should have for a first measurable material property, e.g. stress at break, the user 110) may decide to manufacture a material using a set of input parameters that is identical to the first set of input parameters. Thus, in this example case, the second set of input parameters for manufacturing a material is equal to the first set of input parameters. However, if the output predicted value lies outside the pre-determined range of values that the material should have for a first measurable material property, e.g. stress at break, the user 110 may decide to try a different set of input parameters, either by another iteration of the prediction, as described above, or by manufacturing the material. Either way, at least one manufacturing process of a plurality of manufacturing was replaced by a prediction, resulting in a more efficient way, both in terms of time and resources, to determine how to manufacture a material having a value for a first measurable material property in a pre-determined range of values.

If the user 110 decides to manufacture a material based on the first or second set of input parameters, they may further measure a value of the first measurable material property of the material manufactured based on the first or second set of input parameters. The user 110 may enter this value to their electronic device 120 which thereby obtains the measured value. The electronic device 120 may then provide the measured value for use in training of a predictive model, e.g. to the server 100. To that end, the measured value may be provided to the server 100 in the form of a data set that comprises also the input parameters that were used to manufacture the material. The server 100 may then use the data set in training the predictive model, e.g. in a full training or in an incremental or sequential training, e.g. only considering some of the data sets of the plurality of data sets that were e.g. previously used in training.

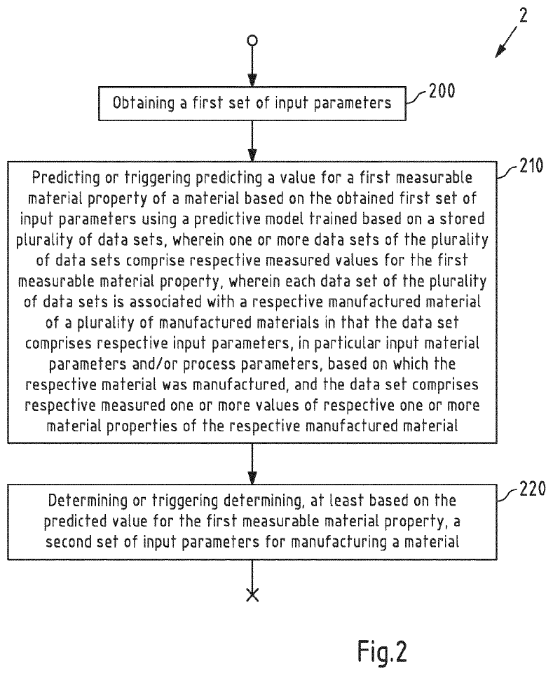

FIG. 2 shows a flowchart 2 showing an example embodiment of the method according to the first example aspect. The method may be performed by an apparatus or a system, e.g. electronic device 120, 130, server 100 or system 1.

Step 200 comprises obtaining a first set of input parameters. For example, if step 200 is performed by an apparatus having a user interface, the first set of input parameters may be obtained by user input. Alternatively, the first set of input parameters may be obtained electronically, e.g. from a storage medium, from scanning an optical pattern that comprises information, e.g. a barcode, or via the Internet.

Step 210 comprises predicting or triggering predicting a value for a first measurable material property of a material based on the obtained first set of input parameters using a predictive model trained based on a stored plurality of data sets, wherein one or more data sets of the plurality of data sets comprise respective measured values for the first measurable material property, wherein each data set of the plurality of data sets is associated with a respective manufactured material of a plurality of manufactured materials in that the data set comprises respective input parameters, in particular input material parameters and/or process parameters, based on which the respective material was manufactured, and the data set comprises respective measured one or more values of respective one or more material properties of the respective manufactured material. Step 210 may be performed after and/or in reaction to step 200. Additionally or alternatively, it may be performed in reaction to a user input, e.g. a user clicking on a button in a user interface on a screen.

It may be part of step 210 that also an uncertainty that relates to the predicted value is determined or the determining of an uncertainty is triggered. Such an uncertainty may be expressed as a value and output alongside the predicted value. However, the uncertainty may alternatively or additionally be used in an additional checking step in between steps 210 and 220. In this additional step, it may be checked whether the uncertainty lies outside a predetermined range of one or more values. If the answer is no, step 220 may be performed. The answer may for example be no if the first set of input parameters comprises a parameter for which there are less than a predetermined number of data sets in the stored plurality of data sets that comprise this parameter as an input parameter. By contrast, if the answer is yes, step 220 may not be performed. Instead, a new first set of input parameters may be requested so that a new iteration starting from step 210 may begin. Taking into account the uncertainty this way may prevent a development of input parameters that is supported by predicted values that are not trusted.

Finally, step 220 comprises determining or triggering determining, at least based on the predicted value for the first measurable material property, a second set of input parameters for manufacturing a material. As described with respect to step 210, step 220 may be performed after and/or in reaction to step 210. Additionally or alternatively, it may be performed in reaction to a user input, e.g. a user clicking on a button in a user interface on a screen. As described above, in some embodiments, it may be performed only after certain conditions have been checked, e.g. whether an uncertainty does not lie outside a predetermined range of one or more values.

The steps 200 to 220 may be performed iteratively and/or repeatedly. A new iteration/repetition may start for example once the preceding iteration/repetition is finished. Additionally or alternatively, a new iteration/repetition may for instance be triggered by a user input. It is not required that each iteration/repetition comprises all steps 200 to 220. Instead, in some iterations/repetitions, a step may be omitted, e.g. step 220 due to an uncertainty that lied outside a predetermined range of one or more values.

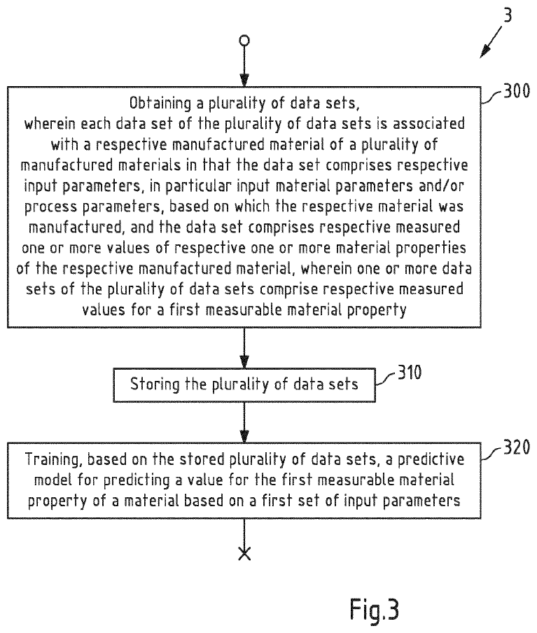

FIG. 3 shows a flowchart 3 showing an example embodiment of the method according to the second example aspect. The method may be performed by an apparatus or a system, e.g. electronic device 120, 130, server 100 or system 1.

Step 300 comprises obtaining a plurality of data sets, wherein each data set of the plurality of data sets is associated with a respective manufactured material of a plurality of manufactured materials in that the data set comprises respective input parameters, in particular input material parameters and/or process parameters, based on which the respective material was manufactured, and the data set comprises respective measured one or more values of respective one or more material properties of the respective manufactured material, wherein one or more data sets of the plurality of data sets comprise respective measured values for a first measurable material property.

Referring back to the simple example of a regression model described before, step 300 may be understood as follows. A set of input parameters may be denoted as xᵢ=(xᵢ₁, . . . , x_{iD})^{T}. A corresponding measured value of a material property, e.g. the first measurable material property, of a material manufactured based on the set of input parameters xᵢ may be denoted as ti. A data set may then refer to a combination of a set of input parameters with a measured value ti, i.e. (xᵢ, tᵢ). A plurality of data sets may thus refer to a plurality of combinations (xᵢ, tᵢ), e.g. for i=0, . . . , N. As described before, the data sets of the plurality of data sets may be obtained e.g. from a plurality of respective apparatuses, where for instance each apparatus is associated with a respective laboratory. The data sets may be obtained, e.g. from the plurality of apparatuses, e.g. sequentially and/or independently of each other.

Step 310 comprises storing the plurality of data sets, e.g. the plurality of combinations (xᵢ, tᵢ). For instance, once a single data set (xᵢ, tᵢ) is obtained, it is stored, e.g. in reaction to the obtaining of the respective data set. This may be repeated multiple times, thus implementing steps 300 and 310.

Step 320 comprises training, based on the stored plurality of data sets, a predictive model for predicting a value for the first measurable material property of a material based on a first set of input parameters. Step 320 may be initiated e.g. after a pre-determined time interval in which a plurality of data sets are obtained and stored according to steps 300 and 310. Alternatively or additionally, step 320 may be initiated e.g. once a pre-determined number of data sets has been obtained and stored according to steps 300 and 310. Further alternatively or additionally, it may be triggered by an indication from another apparatus or a user input.

The specific training procedure may depend on the predictive model that is used. As an example, the regression model referred to earlier may be defined by model parameters w=(w₀, . . . , w_{M-1})^{T}, basis functions φⱼ(x) and the equation

$$y ( x , w ) = {\sum }_{j = 1}^{M - 1} {w}_{j} {φ}_{j} ( x ) = {w}^{T} Φ ( x )$$

For a given first set of input parameters x_{N+1}, the predictive model can predict a value t_{N+1}=y(x_{N+1}, w) for the first measurable material property of a material if the model parameters w are known. Training may be done by determining the model parameters w using the stored plurality of data sets (xᵢ, tᵢ), e.g. by using the normal equations for the least squares problem

$${w}_{ML} = {( {Φ}^{T} Φ )}^{- 1} {Φ}^{T} t$$

$$where$$

$$Φ = ( \begin{matrix}{φ}_{0} ( {x}_{1} ) & … & {φ}_{M - 1} ( {x}_{1} ) \\ ⋮ & ⋱ & ⋮ \\ {φ}_{0} ( {x}_{N} ) & … & {φ}_{M - 1} ( {x}_{N} )\end{matrix} )$$

and t=(t₀, . . . , tₙ)^{T}. By way of example, Gaussian basis function may be used as basis function.

In various embodiments, the apparatus that performs steps 300, 310 and 320 may perform further steps, e.g. step 210. Moreover, an apparatus or a system may perform other combinations of at least some of the steps 300, 310, 320, 200, 210, and 220 in this or in any possible sequence.

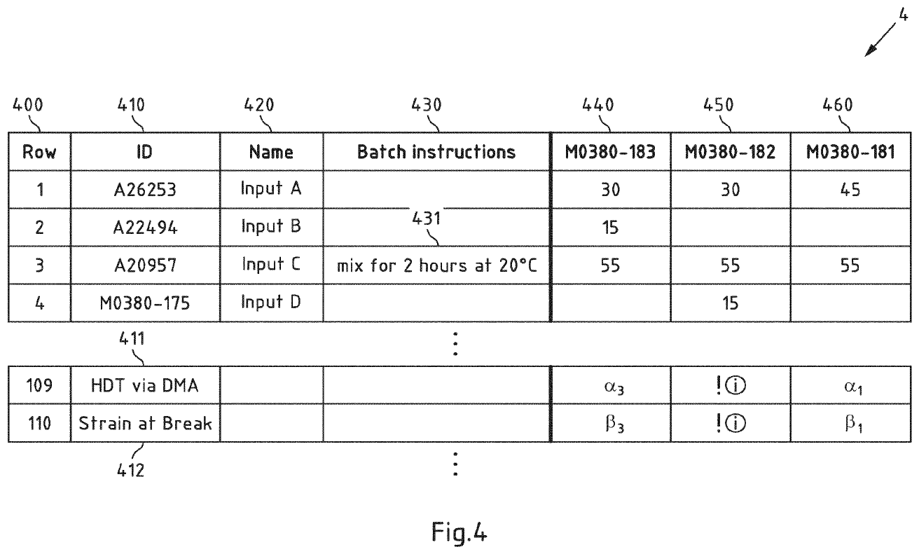

FIG. 4 shows a schematic user interface 4 of an apparatus according to an embodiment of the first and/or second example aspect. The user interface 4 may for example be part of a graphical user interface of a program that is running on an electronic device, e.g. locally. The electronic device may for instance be one of the electronic devices 120, 130. It is also possible that the user interface 4 is part of a web page that is e.g. hosted or accessible via a server 100. Accordingly, the user interface 4 may be shown in a web browser on one of the electronic devices 120, 130, e.g. when the web page is retrieved by the respective electronic device 120, 130 from the server 100. It is to be understood that all actions described with respect to FIG. 4 may be performed by only one apparatus which may also be e.g. an electronic device 120, 130.

In the following, it will be assumed by way of example that the server 100 hosts a web page with the user interface 4 and that it has performed the method according to the second example aspect, i.e. it has performed at least the following: obtaining a plurality of data sets, wherein each data set of the plurality of data sets is associated with a respective manufactured material of a plurality of manufactured materials in that the data set comprises respective input parameters, in particular input material parameters and/or process parameters, based on which the respective material was manufactured, and the data set comprises respective measured one or more values of respective one or more material properties of the respective manufactured material, wherein one or more data sets of the plurality of data sets comprise respective measured values for a first measurable material property, storing the plurality of data sets, and training, based on the stored plurality of data sets, a predictive model for predicting a value for the first measurable material property of a material based on a first set of input parameters.

The user interface 4 shows parts of a table. The table may comprise a number of columns. By way of example, columns 400, 410, 420, 430, 440, 450, and 460 are shown in the table of user interface 4.

Column 400 comprises row numbers to make rows of the table uniquely identifiable. The row number may be increasing by a fixed number from one row to the next row, e.g. 1.

Column 410 comprises IDs. In rows 1 to 4, each of the IDs relates to a respective identifier of a material. The respective materials may be available or used as input materials for manufacturing a material, e.g. having a value for a first measurable material property in a pre-determined range of values. The corresponding names of the respective materials may be denoted in rows 1 to 4 of column 420. As the table is only an example, the materials only have example names, i.e. “Input A”, “Input B”, “Input C”, and “Input D”. Rows relating to further input materials may be added, e.g. by a user. Additionally, a user may for example select a material from a list of, e.g. available or suggested, materials.

Further in column 410, in rows 109 and 110, the cells 411, 412 comprise IDs of examples of measurable material properties, i.e. heat deflection temperature (HDT) via dynamic mechanical analysis (DMA) in cell 411 and strain at break in cell 412. Either of these measurable material properties may be understood to be the first measurable material property referred to in the methods according to the first or second example aspect. Additional or alternative measurable material properties are possible. As described with respect to the materials in rows 1 to 4, rows relating to respective measurable material properties may be added, e.g. by a user. Further, a user may for example select a measurable material property from a list of, e.g. available or suggested, measurable material properties.

Column 430 relates to batch instructions. As an example, cell 431 is an instruction to “mix for 2 hours at 20° C.” the material “Input C” having the ID A20957. Such batch instructions may be considered to be comments. However, a batch instruction may also relate to or represent one or more process parameters which may be used in manufacturing a material.

Columns 440, 450, and 460 relate to respective formulations. They may be considered to be part of a series of attempts to find a set of input parameters for manufacturing a material having a value for a first measurable material property in a pre-determined range of values. For this example, it is assumed that there were various previous attempts which are not shown in the table of user interface 4 and in which respective materials were manufactured based on respective sets of input parameters. Column 460 shows the first attempt that is discussed here. It can be seen that in rows 1 and 3 of column 460 the values 45 and 55 are shown. These values may constitute or be part of a first set of input parameters which were e.g. determined by a user after the previous attempts and entered into the user interface 4. Each of the values indicates how much of the respective input material is used in the formulation of column 460. By way of example, the numbers are in percent of the total amount of input materials used. So in the example user interface 4, the first set of input parameters for the formulation of column 460 comprises the definition of 45% of “Input A” and 55% of “Input C”. However, other units may be used instead or additionally. It is to be understood that the user entering the values in the user interface is a way by which the device presenting the user interface 4 obtains the first set of input parameters.

After the user entered the values 45 and 55 in rows 1 and 3 of column 460, the prediction of values of measurable material properties, e.g. those of cells 411, 412, may be triggered. For example, the user may click on a button (not shown in FIG. 4) that says “Predict”. The web browser of the electronic device displaying the user interface 4 may indicate the click of the button and the first set of input parameters to the server hosting the web page. This indication may trigger the server to predict a value for one or more measurable material properties of a material, e.g. those of cells 411, 412, based on the obtained first set of input parameters. The server may use the predictive model trained based on a stored plurality of data sets, as described above, for the predicting. Once the server finishes the prediction, it may send, to the electronic device displaying the user interface 4, one or more predicted values, e.g. one for each of the measurable material properties denoted in cells 411, 412. The electronic device may display those values as predictions in the user interface 4. By way of example, the predicted values are represented by α₁ and β₁ in column 460, rows 109 and 110 of user interface 4.

The user may see predicted values α₁ and β₁ and e.g. find that one or both of them are not in a respective predetermined range of desired values for the respective measurable material property. Thus, based on one or both of them, the user may determine a second set of input parameters for manufacturing a material. It is observed that the electronic device has triggered the determining of the second set of input parameters for manufacturing a material by outputting, e.g. displaying, one or both of the predicted values α₁ and β₁. However, it is noted that in various other embodiments, the electronic device may request, thus trigger, e.g. the server to determine a second set of input parameters or determine the second set of input parameters itself.

Next, the user may enter the second set of input parameters in the cells of column 450, as shown by way of example for rows 1, 3, and 4. Having done that, the user may again click on the button (not shown in FIG. 4) that says “Predict” to trigger the prediction of values of measurable material properties, e.g. those of cells 411, 412, based on the second set of input parameters (which may be considered to be a new first set of input parameters for a next iteration). The server may use again the previously trained predictive model to predict one or more of the values. Additionally, the server may determine an uncertainty that relates to the predicted value in reaction to the triggering of the prediction. The uncertainty may be derived e.g. from a covariance in the predictive model. However, it has been observed that uncertainties derived e.g. mainly or only from such a covariance may be biased to suggest too often that the predicted values can be trusted. Thus, the server may use a different approach to determine the uncertainties related to the respective predicted values in this example embodiment.

Thus, instead, the server may check whether there are less than a predetermined number of data sets in the stored plurality of data sets that have been used for the training that comprise one of the parameters of the new first set of input parameters as an input parameter. As a result of this check, the server may find that there are indeed less than a predetermined number of data sets in the stored plurality of data sets that have been used for the training that comprise “Input D” as an input parameter. Due to this result, the server may determine that the one or more values predicted based on the second set of input parameters are too uncertain, i.e. the uncertainty is outside a predetermined range of values. This finding may be represented e.g. as a number or e.g. as a Boolean, e.g. “uncertainty=TRUE” when the predetermined range of values comprises or only has the entry “FALSE”. The server may send both the one or more predicted values and/or an information indicating the uncertainty to the electronic device showing the user interface 4. The electronic device could show both the predicted values and the information indicating the uncertainty in the user interface 4. However, this does not prevent that the, e.g. potentially unreliable, predicted values are used for further developing sets of input parameters for finding a set of input parameters for manufacturing a material having a value for a first measurable material property in a pre-determined range of values. Thus, it may be a consequence of the predicted values being too uncertain that the predicted values are not displayed in rows 109, 110 of column 450. In this case, not displaying the predicted values may be seen as a way to not trigger the determining of a second set of input parameters for manufacturing a material by a user at least based on the predicted value for the first measurable material property. However, also in the case that it is not a user that does the determining of the second set of input parameters but e.g. another program e.g. running on the electronic device, not displaying the predicted values may prevent the further use of unreliable predicted values.

Nevertheless, the user may determine e.g. a new set of input parameters and enter it. The values shown in rows 1-3 of column 440 of user interface 4 may be seen as such a new set of input parameters or at least part thereof. It is noted that it may be particularly beneficial to trigger a user or another apparatus to determine a new set of input parameters if the predicted values of a previous iteration were found to be too uncertain. The reason is that the user or apparatus may have experience, data or knowledge that was not used in the training of the predictive model and, thus, was not taken into account in any way for predicting the uncertain values using the predictive model.

Similar to the procedure described for the previous iterations, the user may again click on a button (not shown in FIG. 4) that says “Predict” to trigger the prediction of values of measurable material properties, e.g. those of cells 411, 412, based on the new set of input parameters given in column 440 (which again may be considered to be a new first set of input parameters for a next iteration). The server may then again use the previously trained predictive model to predict one or more of the values and send them to the electronic device. The electronic device may then display them in the user interface 4, as illustrated by α₃ and β₃.

By way of example, the user or e.g. the electronic device may find that α₃ and/or β₃ are values for respective first measurable material properties that lie in respective pre-determined ranges of values. Thus, the set of input parameters defined at least partly in rows 1-3 of column 440 may be considered to be a promising candidate for manufacturing a material having desired material properties. Therefore, a material may be manufactured based on the set of input parameters defined at least partly in rows 1-3 of column 440.

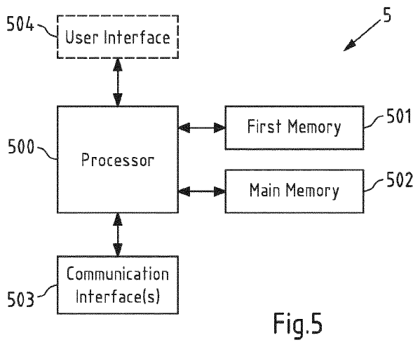

FIG. 5 shows a schematic block diagram of an apparatus 5 according to the first or second example aspect. The apparatus 5 may be adapted to perform the method according to the first and/or second example aspect. By way of example, the apparatus 5 can represent one of the electronic devices 120, 130 or server 100 of the system 1.

By way of example, the processor executes a program causing the apparatus 5 to perform and/or control the method according to the first and/or example second aspect. The program may be stored in the first memory 501. Furthermore, data may be stored in the first memory 501. The data may comprise e.g. a plurality of data sets, each data set for instance comprising respective input parameters, in particular input material parameters and/or process parameters, based on which a respective material was manufactured, and each data set for instance comprising respective measured one or more values of respective one or more material properties of the respective manufactured material. The first memory 501 may be non-volatile.

Additionally, apparatus 5 may comprise a main memory 502. The main memory 502 may be used particularly for storing temporary data during the executing of a program. For instance, apparatus 5 may store a first set of input parameters based on which a value for a first measurable material property should be predicted in the main memory 502.

Additionally, the apparatus 5 may comprise communication interface(s) 503. By way of example, the apparatus 5 can use these communication interface(s) 503 to transmit and receive information and data, for instance over the Internet. The electronic devices 120, 130 may use their respective communication interface(s) 503 for example, amongst others, for communicating with the server 100 of system 1. The server 100 may use its communication interface(s) 503 for communicating with the electronic devices 120, 130 and/or other purposes. Furthermore, the communication interface(s) 503 may be used by the apparatus 5 to communicate with lab equipment, e.g. measurement devices, e.g. for measuring one or more values for respective one or more measurable material properties of one or more manufactured materials.

Optionally, the apparatus 5 may comprise a user interface 504. This may be particularly the case if the apparatus 5 is e.g. an electronic device 120, 130, e.g. a laptop, tablet or smartphone. The user interface 504 may allow the apparatus 5 to exchange information with a user 110, 140. An example of a user interface 504 is a touchscreen. Alternatively, a user interface 504 may comprise a screen and a keyboard and/or a mouse. Other types of user interface 504 are possible as well, e.g. output of audio signals and speech recognition or gesture recognition.

Any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Additionally, the expression “A or B” is to be understood to explicitly disclose “A and B” and “either A or B”. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only examples, and that any feature presented for a particular example embodiment may be used with any aspect of the present disclosure on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program) may also be used in a corresponding manner in an example embodiment of any other category. It should also be understood that presence of a feature in the presented example embodiments shall not necessarily mean that this feature forms an essential feature and cannot be omitted or substituted.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure. Furthermore, any step may happen after another step and/or in reaction to any other step.

In addition to the embodiments described above, the following embodiments are disclosed:

### Embodiment 1

A method for use in manufacturing a material having a value for a first measurable material property in a pre-determined range of values, the method comprising:
obtaining a first set of input parameters;
predicting or triggering predicting a value for the first measurable material property of a material based on the obtained first set of input parameters using a predictive model trained based on a stored plurality of data sets, wherein one or more data sets of the plurality of data sets comprise respective measured values for the first measurable material property, wherein each data set of the plurality of data sets is associated with a respective manufactured material of a plurality of manufactured materials in that the data set comprises respective input parameters, in particular input material parameters and/or process parameters, based on which the respective material was manufactured, and the data set comprises respective measured one or more values of respective one or more material properties of the respective manufactured material; and
determining or triggering determining, at least based on the predicted value for the first measurable material property, a second set of input parameters for manufacturing a material.

### Embodiment 2

The method of embodiment 1, wherein the determining of the second set of input parameters for manufacturing the material is triggered by outputting the predicted value for the first measurable material property, in particular to a user that determines the second set of input parameters for manufacturing the material.

### Embodiment 3

The method of any of embodiments 1-2, further comprising:
determining or triggering determining an uncertainty that relates to the predicted value.

### Embodiment 4

The method of embodiment 3, wherein the uncertainty is determined based on the obtained first set of input parameters and the stored plurality of data sets.

### Embodiment 5

The method of any of embodiments 3-4, wherein the second set of input parameters is further based on the determined uncertainty.

### Embodiment 6

The method of any of embodiments 3-5, wherein the determining of the second set of input parameters for manufacturing the material is not triggered and/or performed if the uncertainty lies outside a predetermined range of one or more values.

### Embodiment 7

The method of any of embodiments 3-6, wherein the uncertainty lies outside the predetermined range of one or more values if the first set of input parameters comprises a parameter for which there are less than a predetermined number of data sets in the stored plurality of data sets that comprise this parameter as an input parameter.

### Embodiment 8

The method of any of the embodiments 1-7, wherein the first set of input parameters is obtained by or in reaction to a user input.

### Embodiment 9

The method of any of the embodiments 1-8, wherein the method is performed iteratively, and wherein the first set of input parameters of an iteration corresponds to the second set of input parameters of a preceding iteration.

### Embodiment 10

The method of any of the embodiments 1-9, further comprising:
manufacturing or triggering manufacturing a material based on the first or second set of input parameters.

### Embodiment 11

The method of embodiment 10, further comprising:
measuring a value of or obtaining a measured value of the first measurable material property of the material manufactured based on the first or second set of input parameters, and providing the measured value for use in training of a predictive model.

### Embodiment 12

The method of any of the embodiments 1-11, wherein the training of the predictive model and/or the predicting of the value for the first measurable material property of a material based on the obtained first set of input parameters using the predictive model is done using a server.

### Embodiment 13

The method of any of the embodiments 1-12, wherein the stored plurality of data sets is sparse with respect to one or more input parameters.

### Embodiment 14

A method for use in manufacturing a material having a value for a first measurable material property in a pre-determined range of values, the method comprising:
obtaining a plurality of data sets,
   wherein each data set of the plurality of data sets is associated with a respective manufactured material of a plurality of manufactured materials in that the data set comprises respective input parameters, in particular input material parameters and/or process parameters, based on which the respective material was manufactured, and the data set comprises respective measured one or more values of respective one or more material properties of the respective manufactured material,
   wherein one or more data sets of the plurality of data sets comprise respective measured values for the first measurable material property;
storing the plurality of data sets; and training, based on the stored plurality of data sets, a predictive model for predicting a value for the first measurable material property of a material based on a first set of input parameters.

### Embodiment 15

The method of embodiment 14, further comprising: selecting a subset of the plurality of data sets based on the respective one or more material properties of the respective manufactured material of which the respective data set of the plurality of data sets comprises respective measured one or more values, wherein data sets of the plurality of data sets that are not part of the selected subset are disregarded in the training of the predictive model.

### Embodiment 16

The method of any of the embodiments 14-15, wherein one or more input parameters are disregarded in the training of the predictive model, in case the number of data sets for the training of the predictive model comprising the one or more input parameters is less than or equal to a predetermined number.

### Embodiment 17

The method of any of the embodiments 14-16, further comprising:
identifying two or more data sets of the plurality of data sets, wherein at least one data set of the two or more data sets comprises a first input parameter, wherein at least one other data set of the two or more data sets comprises a different first input parameter, and wherein both first input parameters relate to a same type of input; and
determining a harmonized first input parameter for the two or more data sets for use in training of the predictive model.

### Embodiment 18

The method of any of the embodiments 14-17, wherein the plurality of data sets is obtained from a plurality of apparatuses, the method further comprising:
providing, to the plurality of apparatuses, information for harmonizing input parameters relating to a same type of input.

### Embodiment 19

The method of any of the embodiments 14-18, further comprising:
obtaining a measured value of the first measurable material property of the material manufactured based on the first set of input parameters, and
using the measured value in training the predictive model.

### Embodiment 20

The method of embodiment 19, wherein the training of the predictive model in which the measured value is used is an incremental or sequential training.

### Embodiment 21

The method of any of the embodiments 14-20, wherein the method is performed iteratively and/or repeatedly.

### Embodiment 22

The method of any of the embodiments 1-21, wherein the predictive model is a regression model.

### Embodiment 23

The method of any of the embodiments 1-22, wherein the stored plurality of data sets is sparse with respect to one or more input parameters.

### Embodiment 24

The method of any of the embodiments 1-23, wherein the training of the predictive model is done using a server.

### Embodiment 25

The method of any of the embodiments 1-13, further comprising one or more actions of the method of any of the embodiments 13-24.

### Embodiment 26

The method of any of the embodiments 13-24, further comprising one or more actions of the method of any of the embodiments 1-13.

### Embodiment 27

An apparatus or system configured to perform and/or control or comprising respective features for performing and/or controlling the method according to any of the embodiments 1-26.

### Embodiment 28

An apparatus or system comprising at least one processor and at least one memory including computer program code, the at least one memory and the computer program code configured to, with the at least one processor, cause the apparatus or system at least to perform and/or control the method according to any of the embodiments 1-26.

### Embodiment 29

The apparatus according to any of the embodiments 27-28, wherein the apparatus is useable in manufacturing a material having a value for a first measurable material property in a pre-determined range of values

### Embodiment 30

A system comprising a first apparatus configured to perform and/or control or comprising respective features for performing and/or controlling the method according to any of the embodiments 1-13, the system further comprising a second apparatus configured to perform and/or control or comprising respective features for performing and/or controlling the method according to any of the embodiments 14-24.

### Embodiment 31

A system comprising a first apparatus comprising at least one processor and at least one memory including computer program code, the at least one memory and the computer program code configured to, with the at least one processor, cause the apparatus or system at least to perform and/or control the method according to any of the embodiments 1-13, the system further a second apparatus comprising at least one processor and at least one memory including computer program code, the at least one memory and the computer program code configured to, with the at least one processor, cause the apparatus or system at least to perform and/or control the method according to any of the embodiments 14-24.

### Embodiment 32

A computer program when executed by a processor causing an apparatus to perform and/or control the actions of the method according to any of the embodiments 1-26.

### Embodiment 33

A tangible, non-transitory computer-readable medium storing a computer program code, the computer program code when executed by a processor causing an apparatus to perform and/or control the method according to any of the embodiments 1-26.

The present disclosure has been described above by employing example embodiments. It should be noted that there are alternative ways and variations which are obvious to a skilled person in the art and can be implemented without deviating from the scope of the appended claims.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method for use in manufacturing a material having a value for a first measurable material property in a pre-determined range of values, the method comprising:
obtaining a first set of input parameters;
predicting or triggering predicting a value for the first measurable material property of a material based on the obtained first set of input parameters using a predictive model trained based on a stored plurality of data sets, wherein one or more data sets of the plurality of data sets comprise respective measured values for the first measurable material property,
wherein each data set of the plurality of data sets is associated with a respective manufactured material of a plurality of manufactured materials, wherein the data set comprises respective input parameters, wherein the respective material was manufactured based on the respective input parameters, and wherein the data set comprises respective measured one or more values of respective one or more material properties of the respective manufactured material; and
determining or triggering determining, at least based on the predicted value for the first measurable material property, a second set of input parameters for manufacturing a material.

2. The method of claim 1, wherein the determining of the second set of input parameters for manufacturing the material is triggered by outputting the predicted value for the first measurable material property to a user that determines the second set of input parameters for manufacturing the material.

3. The method of claim 1, further comprising:
determining or triggering determining an uncertainty that relates to the predicted value.

4. The method of claim 3, wherein the uncertainty is determined based on the obtained first set of input parameters and the stored plurality of data sets.

5. The method of claim 3, wherein the second set of input parameters is further based on the determined uncertainty.

6. The method of claim 3, wherein the determining of the second set of input parameters for manufacturing the material is not triggered and/or performed if the uncertainty lies outside a predetermined range of one or more values.

7. The method of claim 6, wherein the uncertainty lies outside the predetermined range of one or more values if the first set of input parameters comprises a parameter for which there are less than a predetermined number of data sets in the stored plurality of data sets that comprise this parameter as an input parameter.

8. The method of claim 1, wherein the first set of input parameters is obtained by or in reaction to a user input.

9. The method of claim 1, wherein the method of claim 1 is performed iteratively, and wherein the first set of input parameters of an iteration corresponds to the second set of input parameters of a preceding iteration.

10. The method of claim 1, further comprising:
manufacturing or triggering manufacturing a material based on the first or second set of input parameters.

11. The method of claim 10, further comprising:
measuring a value of or obtaining a measured value of the first measurable material property of the material manufactured based on the first or second set of input parameters, and
providing the measured value for use in training of a predictive model.

12. The method of claim 1, wherein the training of the predictive model and/or the predicting of the value for the first measurable material property of a material based on the obtained first set of input parameters using the predictive model is done using a server.

13. The method of claim 1, wherein the stored plurality of data sets is sparse with respect to one or more input parameters.

14. A method for use in manufacturing a material having a value for a first measurable material property in a pre-determined range of values, the method comprising:
obtaining a plurality of data sets, wherein each data set of the plurality of data sets is associated with a respective manufactured material of a plurality of manufactured materials, wherein the data set comprises respective input parameters wherein the respective material was manufactured based on the respective input parameters, and wherein the data set comprises respective measured one or more values of respective one or more material properties of the respective manufactured material,
wherein one or more data sets of the plurality of data sets comprise respective measured values for the first measurable material property;
storing the plurality of data sets; and
training, based on the stored plurality of data sets, a predictive model for predicting a value for the first measurable material property of a material based on a first set of input parameters.

15. The method of claim 14, further comprising:
selecting a subset of the plurality of data sets based on the respective one or more material properties of the respective manufactured material of which the respective data set of the plurality of data sets comprises respective measured one or more values, wherein data sets of the plurality of data sets that are not part of the selected subset are disregarded in the training of the predictive model.

16. The method of claim 14, wherein one or more input parameters are disregarded in the training of the predictive model when the number of data sets for the training of the predictive model comprising the one or more input parameters is less than or equal to a predetermined number.

17. The method of claim 14, further comprising:
identifying two or more data sets of the plurality of data sets, wherein at least one data set of the two or more data sets comprises a first input parameter, wherein at least one other data set of the two or more data sets comprises a different first input parameter, and wherein both first input parameters relate to a same type of input; and
determining a harmonized first input parameter for the two or more data sets for use in training of the predictive model.

18. The method of claim 14, wherein the plurality of data sets is obtained from a plurality of apparatuses, the method further comprising:
providing, to the plurality of apparatuses, information for harmonizing input parameters relating to a same type of input.

19. The method of claim 14, further comprising:
obtaining a measured value of the first measurable material property of the material manufactured based on the first set of input parameters, and
using the measured value in training the predictive model.

20. The method of claim 19, wherein the training of the predictive model in which the measured value is used is an incremental or sequential training.

21-24. (canceled)
